(19) United States
(12) Patent Application Publication
(10) Pub. No.: US 2010/0283390 A1
(43) Pub. Date: Nov. 11, 2010

(54) PLASMA LAMP

(75) Inventors: Lars Brandt, Kreiensen (DE); Harry Wagener, Alfed (DE); Margareta Hamel, Ebergotzen (DE)

Correspondence Address: DUANE MORRIS LLP - DC, 505 9th Street, Suite 1000, WASHINGTON, DC, 20004-2166, US

(73) Assignee: Auer Lighting GmbH, Bad Gandersheim (DE)

(21) Appl. No.: 12/768,604

(22) Filed: Apr. 27, 2010

(30) Foreign Application Priority Data
Apr. 28, 2009 (DE) 10 2009 018 840.1

(51) Int. Cl. H01J 25/50

(52) U.S. Cl. 315/39.51

(57) ABSTRACT

A plasma lamp having a lamp bulb (1) which contains a material which is suitable for plasma formation with microwave excitation radiation, having a supply line (9) for supplying the microwave excitation radiation to the lamp bulb (1) and having a reflector (11), which at least partially surrounds the lamp bulb (1), for directing the light which is emitted from the plasma in the lamp bulb (1), wherein the lamp bulb (1) is arranged within a microwave resonator (5) such that a high microwave field strength is achieved in the area of the lamp bulb (1), and wherein the microwave resonator (5) has metallic walls (6, 4, 7), at least one wall section (7) of which is designed to be light-transmissive with an electrically conductive shielding structure, allows a compact design and an improved light yield in that the reflector (11) is arranged within the microwave resonator (5), and in that the microwave resonator (5), together with the reflector (11), is matched to optimum energy introduction into the lamp bulb (1).

The invention relates to a plasma lamp having a lamp bulb which contains a material which is suitable for plasma formation with microwave excitation radiation, having a supply line for supplying the microwave excitation radiation to the lamp bulb and having a reflector, which at least partially surrounds the lamp bulb, for directing the light which is emitted from the plasma in the lamp bulb, wherein the lamp bulb is arranged within a microwave resonator such that a high microwave field strength is achieved in the area of the lamp bulb, and wherein the microwave resonator has metallic walls, at least one wall section of which is designed to be light-transmissive with an electrically conductive shielding structure.

A plasma lamp such as this is disclosed in EP 1 432 012 A2. The microwave excitation radiation is generated by a magnetron as the microwave source, and is passed via a waveguide into a cylindrical microwave resonator, on whose longitudinal axis the lamp bulb is arranged centrally. This is preferably filled with an inert gas, which is ionized by the microwave energy to form a plasma, and thus emits light. The light can emerge from the microwave resonator through an upper, light-transmissive wall section, which is formed by a grid-like metallic structure in the form of a network. The microwave resonator together with the lamp bulb is located within a reflector, which is normally in the form of a funnel and has a circular cross section, with the cylindrical microwave resonator being arranged concentrically with respect to the circular cross section of the reflector.

Furthermore, DE 43 07 965 A1 discloses a microwave lamp such as this, in which a rotating field is produced by injection of two mutually phase-shifted microwave fields in the microwave resonator, in order to achieve unified plasma excitation—and thus unified light emission. Alternatively, it is known for the microwave field to be left static, and for the lamp bulb to be caused to rotate about its longitudinal axis.

The known plasma lamps are normally filled with sulfur and have therefore become known as sulfur plasma lamps. The system of the plasma lamp allows a high light yield. However, the known plasma lamps have the disadvantage that the wire cylinder which surrounds the lamp bulb at the side and in the emission direction shields a portion of the light, and that that metal reflector which is arranged outside the microwave resonator must be of a considerable size.

The object of the present invention is therefore to design a plasma lamp of the type mentioned initially so as to allow a smaller physical shape with an optimized light yield.

According to the invention, this object is achieved by a plasma lamp of the type mentioned initially, characterized in that the reflector is arranged within the microwave resonator, and in that the microwave resonator, together with the reflector, is matched to optimum energy introduction into the lamp bulb.

In the plasma lamp according to the invention, the reflector is therefore located within the microwave resonator. This is made possible by the reflector and the resonator being matched to one another, and by optimizing the energy introduced into the plasma lamp.

In a first embodiment of the invention, the reflector is not in the form of a metallic reflector but consists of a base body through which microwaves can pass, preferably with a coating through which microwaves pass but which reflects light. This arrangement has the advantage that there is no interaction with the injected microwave radiation. A coating such as this is preferably a non-metallic interference coating.

The interference coating is preferably in the form of a cold-light mirror and therefore has a high reflection capability for visible light, while the microwave excitation radiation and any thermal radiation pass through the coating with virtually no attenuation.

In the first exemplary embodiment of the invention, the reflector is preferably composed of a material which is suitable for microwaves, specifically glass, ceramic, glass-ceramic or suitable plastics. The coating is preferably an interference coating with coating materials which are transparent for microwaves, in particular oxides, nitrides or the like. The microwave field in the microwave resonator is therefore not influenced, or is influenced only slightly, by the reflector. Since the light which is generated in the lamp bulb is already directed in the desired manner by the reflector being seated directly on the lamp bulb, it emerges completely from the electrically conductive cover which closes the microwave resonator.

Furthermore, the use of the non-metallic interference coating allows the reflectance to be increased in comparison to the previously used metal reflectors (in particular aluminum reflectors). While the conventional aluminum layers have a reflectance of about 90%, the reflectance of the interference coatings, for example based on TiO₂/SiO₂ alternating layer packs, is normally in the range from 94 to 97%.

In a second embodiment of the invention, the reflector which is arranged in the resonator may have a metallic layer as a reflective coating or consist entirely of a metallic base body with a metallically reflective surface. This assumes that the microwave radiation is injected in a suitable manner within the reflector such that the plasma lamp can be ignited and can be operated in a stable manner.

A further increase in the efficiency of the plasma lamp according to the invention can be achieved by designing it for operation at a microwave frequency of >5 GHz. A 5.8 GHz magnetron is preferably used in this case. This microwave excitation frequency is considerably higher than the excitation frequencies used in conventional sulfur plasma lamps. The higher frequencies allow the microwave components to have smaller dimensions, as a result of which the plasma lamp according to the invention can also for this reason be produced with smaller dimensions than conventional plasma lamps.

The plasma lamp according to the invention makes it possible to use all suitable materials which can be excited to emit light by microwave excitation radiation. These include the known fillings with sulfur components, or else other possible fillings, for example with disposium iodide, mercury iodide, etc., as well as combinations of these materials.

In one preferred embodiment of the invention, the shielding electrically conductive structure of the cover is a light-transmissive electrically conductive coating on a light-transmissive substrate. For this purpose, the electrically conductive coating can be made so thin that it is sufficiently conductive to enclose the microwave field in the microwave resonator, but is transmissive or at least translucent for visible light. Alternatively, it is possible to apply a light-transmissive coating in the form of a grid to a substrate, which coating shields the microwave field in the form of a Faraday cage, but allows light to pass through the spaces between the metallic grid lines. In the case of the present invention it is, of course, also possible for the light-transmissive wall section to be provided simply by a grid-like wire mesh. It is evident that the specific embodiment of a grid form is not relevant. For the purposes of this application, a “grid form” therefore means any regular or irregular pattern which ensures adequate cohesive conductivity for the shielding of the microwave field, while on the other hand leaving adequate intermediate spaces through which the light which is generated in the lamp bulb and is directed by the reflector can emerge.

Alternatively, instead of a coating composed of metal, the light-transmissive substrate may also be provided with an electrically conductive coating composed of a transparent oxide. Such coatings, which are electrically conductive, but are at the same time transparent in the visible band, are in principle known to a person skilled in the art. For example, they are used for thermal insulation for windows or touch screens. In this case, the coatings consist of oxides which are doped with another oxide and therefore have characteristics similar to a semiconductor. The best known in this case is indium tin oxide (ITO), in which indium oxide is doped with a proportion of about 5-10% of tin oxide. The doping makes the otherwise not particularly conductive indium oxide conductive, and, if the ITO coating is sufficiently thick, it is able to achieve an electrical conductivity which is adequate to reflect microwaves. Because of its electrical conductivity, this type of coating acts like a thin metal layer.

In a further preferred embodiment of the invention, the lamp bulb is arranged such that it can be moved on a center axis of the reflector, such that the geometry of the lamp bulb relative to the reflector can be varied, thus allowing the directing and focusing of the light to be adjusted. In another embodiment of the invention, instead of the lamp bulb being introduced into the reflector from underneath, it is introduced from the side, with an attachment in the form of a rod, by means of which the lamp bulb is mounted in a lamp holder, being passed out through a side opening through the reflector. In this embodiment, the bulb with the filling gas which emits light must be located at a suitable point in the reflector, in the same way as in the previous embodiment.

The plasma lamp according to the invention allows a light yield of 120 lumen/W or more. Thus, if a conventionally available magnetron with a power of 800 W is used as the microwave source, it is possible to achieve a luminous flux of more than 100,000 lumens. In any case, it is also possible to use a plasma lamp according to the invention with more powerful magnetrons, thus making it possible to produce even more powerful plasma lamps, as well. In this case, for a higher microwave power, it may be necessary to match the diameter of the lamp bulb to the higher power. The plasma lamp according to the invention is currently operated with lamp bulb diameters of about 30-35 mm.

The filling pressure of the filling material in the lamp bulb can be adjusted as a function of the filling material used, of the size of the lamp bulb and/or of the electrical power of the magnetron.

There is no restriction to the fillings which can be used for the plasma lamp according to the invention. Conventional gas mixtures composed of argon and sulfur may be used, although it is also possible to use gas mixtures with other materials, for example selenium and/or tellurium in addition to an inert gas, preferably noble gas, which absorbs the microwave energy and emits the absorbed energy to the other gas components, for example sulfur and its molecules, thus exciting them and emitting photons when they fall back to the low-energy state. This object can also be achieved by inert gases, preferably noble gases.

For the use of the plasma lamp according to the invention, it is important that its function be independent of the installation orientation. In this way, the plasma lamp according to the invention differs from conventional discharge lamps, in particular CDM lamps (ceramic discharge metal). In these known lamps, a color breakdown occurs between red and green as a result of the interaction of the metal salts contained (of rare-earth metals, such as scandium) with the hot bulb. Such a color breakdown does not occur in the plasma lamps according to the invention because they normally do not contain any metal salts. Although there may still be a small proportion of solids, in particular solid sulfur, in the bulb, the vast majority of the sulfur (in the case of a sulfur plasma lamp) is in the gaseous state, because of the high temperatures in the bulb. The high temperature of the sulfur is in this case achieved by energy transfer from the argon atoms, which are highly excited by the microwaves, or other highly excited atoms or molecules.

The bulb of the plasma lamp can be mounted in a fixed manner. Alternatively, it is possible to rotate the bulb about its longitudinal axis during operation of the lamp, in order to unify the light excitation by the microwaves. There are therefore no preferred points in the plasma lamp at which the sulfur can primarily precipitate. There is also accordingly no color asymmetry of the light emission, as in the case of conventional CDM lamps.

The light emitted from the plasma lamp according to the invention has a comparatively small UV component in comparison to conventional discharge lamps, in which considerable amounts of UV radiation are created, in particular by the excitation of mercury atoms in the gas composition. In the case of a sulfur-argon mixture, as is used by way of example in the plasma lamp according to the invention, the emission spectrum contains a relatively small component in the UV range in comparison to the visible range. Virtually no UV radiation whatsoever is now emitted below 350 nm.

The plasma lamp according to the invention makes it possible to use very small lamp bulbs, whose diameter can thus be <35 mm, preferably <20 mm, and particularly preferably <10 mm. In this case, for optimization purposes, it may be worthwhile varying the filling pressure or varying the gas composition.

Conventionally, the shape of the bulb used in this case may be spherical. However, a stretched form of the bulb in the direction of the optical axis is preferable, as a result of which the lamp bulb has a slightly oval shape in this direction. This embodiment is particularly advantageous for an elliptical reflector, in which the light beams which originate in the vicinity of the optical axis can generally be deflected better, for geometric reasons, into a small aperture, than light beams whose source is further away from the optical axis.

The plasma lamp according to the invention has the advantage that it can be dimmed well in comparison to conventional discharge lamps. The plasma lamp according to the invention can be dimmed continuously variably without any significant deterioration in the emission spectrum. In particular, the color reproduction Ra (or CRI) does not deteriorate noticeably when using a small applied electrical power, as a result of which the lamp can still be operated with good color reproduction at low power, without having to move complex dimmer disks, which can be highly loaded thermally, into the beam path, as is the case with conventional stage spotlights. The conventional dimming also does not lead to any energy saving as is achieved with the plasma lamp according to the invention, which can be dimmed well. These characteristics allow the plasma lamp according to the invention to be used particularly well for street lighting since the night-time reduction which is normally used nowadays invariably has a disadvantageous effect on the traffic and on the feeling of security of the citizens, as a result of which dimming of a plasma lamp such as this according to the invention not only makes it possible to save energy but also avoids the disadvantages of switching off completely at night. Since the color characteristics of the emitted light remain virtually the same when it is dimmed, those out at night without any lighting, particularly pedestrians, can still be identified well, even in a reduced light intensity.

In contrast to conventional discharge lamps, the plasma lamp according to the invention can be switched on and off very quickly. In addition, the total life of the lamp is not significantly reduced by frequently switching it on and off, since the lamp does not contain any electrodes which could suffer from the process of switching on and off. The plasma lamp according to the invention is therefore very highly suitable for use in the area of obstruction lighting, for example as an obstruction light on wind rotors, towers, factory chimneys, etc. The lamp according to the invention can be operated immediately again with the full light output when it is switched off only briefly. When switched off for a longer time, the bulb cools down. In the case of a sulfur filling, the sulfur changes to the solid state. It takes less than 20 seconds before the full light output is achieved again from the cold state.

The plasma lamp according to the invention is particularly suitable for stage lighting, for architecture illumination (facades, large spaces, parks, stadiums, building sites, etc.), for digital cinema projection, for simulation of daylight in gardening centers, and for illumination of large halls, department stores and shopping malls, etc.

The plasma lamp according to the invention can also be used as a central light source in that its emitted light is imaged onto a small aperture using a preferably elliptical reflector, in which one side of a glass-fiber bundle is located, from which a multiplicity of glass fibers emerge, which can be distributed between a multiplicity of single, individual light sources.

The invention will be explained in more detail in the following text with reference to one exemplary embodiment which is illustrated in the drawing, in which:

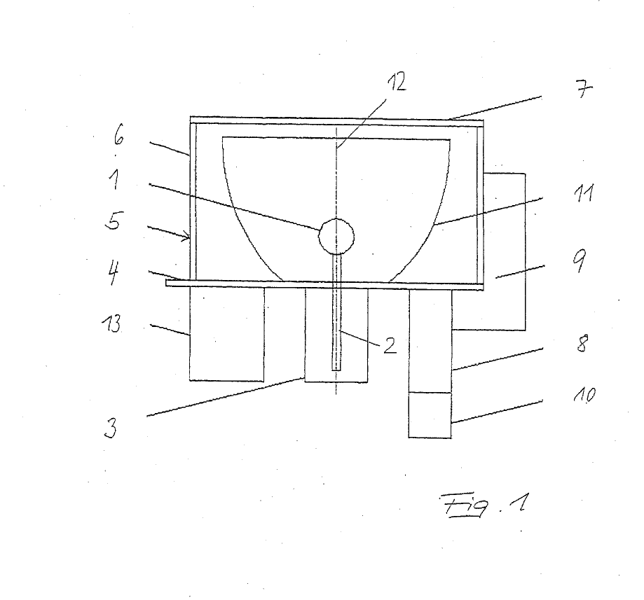

FIG. 1 shows a section through a schematic arrangement of a first embodiment of a plasma lamp according to the invention; and

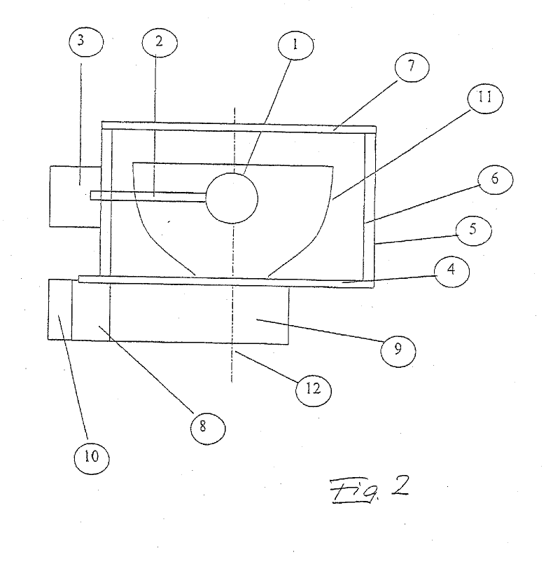

FIG. 2 shows a section through a schematic arrangement of a second embodiment of a plasma lamp according to the invention.

As shown in FIG. 1, a spherical lamp bulb 1 composed of a suitable glass, quartz glass or the like, is located at the end of an attachment 2, which is in the form of a rod and by means of which the lamp bulb 1 is mounted in a lamp holder 3. The attachment 2 projects through a metal plate 4, which forms a base of a cylindrical microwave resonator 5. The metal plate 4 and a cylindrical casing wall 6 of the microwave resonator 5 are composed of metal, while a cover disk 7, which is opposite the base 4 and closes the microwave resonator 5, is composed of a suitable glass and is provided with an electrically conductive coating in order to shield the surrounding area from microwaves emerging from the microwave resonator 5. Microwaves produced by a microwave generator 8 are introduced into the microwave resonator via a waveguide 9, at the side, through a slot into the microwave resonator 5. The microwave generator 8 is electrically supplied by a supply unit 10.

According to the invention, a reflector 11 is located within the microwave resonator 5 and surrounds the lamp bulb 1 concentrically with respect to the vertical axis. The reflector 11 preferably consists of a suitable non-metallic body, through which microwaves can pass and which does not interfere with the microwave field in the microwave resonator 5. The glass body 11 is provided with a non-metallic coating through which microwaves pass, but which reflects light emitted from the lamp bulb 1. In particular, an interference coating can be used for this purpose, which is formed in a manner known per se from alternating layer packs, for example of TiO₂ and SiO₂. Interference coatings such as these may be in the form of a cold-light mirror coating, thus resulting in high reflectivity for visible light, while microwave radiation and any UV and thermal radiation components which may be present can pass through. The reflector is rotationally symmetrical with respect to a center axis 12, and the lamp bulb 1 also has the same rotational symmetry about the center axis 12, with the lamp bulb 1 being spherical in the exemplary embodiment illustrated in FIG. 1. However, the lamp bulb may also have other shapes, for example oval, elliptical or the like. The bulb shape is chosen such that the microwave is optimally coupled to the filling gas in order to change as high a proportion of the gas in the filling as possible to the plasma state. The lamp bulb 1 may be arranged such that it can be moved translationally on the center axis 12, thus making it possible to vary the spatial arrangement of the lamp bulb 1 with respect to the reflector 11, thus making it possible to vary the directing and focusing of the light beam.

The metal plate which forms the base of the microwave resonator 5 has interruptions through which a ventilation device 13 can introduce cooling air into the microwave resonator, in order to cool the lamp bulb 1, which can become very hot during operation. The air flow can be introduced into the microwave resonator 5 by a fan or by compressed air.

In the exemplary embodiment illustrated in FIG. 2, all the parts are present as in FIG. 1. However, the lamp bulb 1 is mounted at the side, as a result of which the attachment which is in the form of a rod passes through the reflector 11 at the side, and is mounted in the lamp holder 3 to the side of the microwave resonator 5. Furthermore, the wave guide 9 to which the microwave generator 8 is coupled is arranged directly adjacent to the metal plate 4 which forms the base of the microwave resonator 5, as a result of which the microwave energy is injected from the metal plate 4 in the direction of the longitudinal axis 12 of the microwave resonator 5, that is to say also directly into the interior of the reflector 11. It is clear from this that the microwaves can also be injected into the resonator 5 via a waveguide at other positions. For this embodiment in particular, it is possible for the reflector 11 to consist of a metallic base body, or to have a metallic coating.

In one preferred embodiment, the lamp bulb 1 is fitted in the lamp holder 3 such that it can rotate, in order to achieve better uniformity of the excitation of the gas mixture in the lamp bulb 1. The rotation capability can be dispensed with if the intensity of the microwave field can be adjusted such that a sufficiently high and uniform microwave field strength is achieved in the area of the lamp bulb 1.

Patent claims:

1. Plasma lamp having a lamp bulb (1) which contains a material which is suitable for plasma formation with microwave excitation radiation, having a supply line (9) for supplying the microwave excitation radiation to the lamp bulb (1) and having a reflector (11), which at least partially surrounds the lamp bulb (1), for directing the light which is emitted from the plasma in the lamp bulb (1), wherein the lamp bulb (1) is arranged within a microwave resonator (5) such that a high microwave field strength is achieved in the area of the lamp bulb (1), and wherein the microwave resonator (5) has metallic walls (6, 4, 7), at least one wall section (7) of which is designed to be light-transmissive with an electrically conductive shielding structure, characterized in that the reflector (11) is arranged within the microwave resonator (5), and in that the microwave resonator (5), together with the reflector (11), is matched to optimum energy introduction into the lamp bulb (1).

2. Plasma lamp according to claim 1, characterized in that the reflector (11) consists of a base body through which microwaves pass.

3. Plasma lamp according to claim 1 or 2, characterized in that the reflector (11) is provided with a coating through which microwaves pass and which reflects light.

4. Plasma lamp according to claim 3, characterized in that the reflector (11) has a non-metallic interference coating as a reflective coating.

5. Plasma lamp according to claim 4, characterized in that the interference coating is in the form of a cold-light coating.

6. Plasma lamp according to claim 1 or 2, characterized in that the reflector (11) has a metallic layer as a reflective coating.

7. Plasma lamp according to claim 1, characterized in that the reflector (11) consists of a metallic base body with a metallically reflective surface.

8. Plasma lamp according to one of claims 1 to 7, characterized in that the plasma lamp is designed for operation at a microwave frequency of >5 GHz.

9. Plasma lamp according to one of claims 1 to 8, characterized in that the electrically conductive shielding structure is a light-transmissive, electrically conductive coating on a light-transmissive substrate.

10. Plasma lamp according to one of claims 1 to 8, characterized in that the shielding electrically conductive structure is a grid-like coating on a light-transmissive substrate.

11. Plasma lamp according to one of claims 1 to 8, characterized in that the shielding electrically conductive structure is a grid-like wire mesh.

12. Plasma lamp according to one of claims 1 to 11, characterized by the lamp bulb (1) having a maximum diameter at right angles to a center axis (12) of <35 mm.

13. Plasma lamp according to claim 12, characterized in that the diameter is <20 mm.

14. Plasma lamp according to claim 13, characterized in that the diameter is <10 mm.
